(19) United States
(12) Patent Application Publication
(10) Pub. No.: US 2025/0153817 A1
(43) Pub. Date: May 15, 2025

(54) Devices for Displaying Nautical Symbols

(71) Applicant: OCEAN INFINITY GROUP LTD., London (GB)

(72) Inventors: Andy Ferdinand, Jakarta (ID); Brandon Tan Cong Sheng, Johor (MY); Harvey Wong, Middlesex (GB); Jonathan James Tang, Hong Kong (HK); Shefali Bagaria, London (GB)

(21) Appl. No.: 18/835,798

(22) PCT Filed: Feb. 8, 2023
(86) PCT No.: PCT/EP2023/053088

§ 371 Date: Aug. 5, 2024

(30) Foreign Application Priority Data
Feb. 9, 2022 (GB) 2201661.2

(51) Int. Cl. B63B 45/04

(52) U.S. Cl. CPC B63B 45/04

(57) ABSTRACT

A device for displaying nautical symbols on a vessel is provided. The device includes a first roller, a second roller, an actuator, and a first processor. The first and second rollers are configured to support a banner comprising a plurality of symbols and to furl the respective ends of the banner such that a symbol in the plurality of symbols is positioned for display between the first roller and the second roller. The actuator is configured to rotate at least one of the rollers. The first processor is configured to control the actuator. An apparatus for displaying a plurality of nautical symbols on a vessel; a computer-implemented method of adjusting a displayed symbol on a device; and a system which comprises a device for displaying nautical symbols on a vessel and a second processor are also provided.

### TECHNICAL FIELD

The disclosure relates to devices for displaying nautical symbols, and in particular such devices for displaying nautical symbols on a vessel. The disclosure also relates to apparatuses comprising such devices, methods of adjusting a displayed nautical symbol on such a device, and systems comprising such a device.

### BACKGROUND

Signal flags and day shapes must be displayed by ships and other vessels at sea, for example to indicate restricted maneuverability or being under the supervision of a pilot. Displaying these flags and shapes is required by international regulations, helps improve communication and safety at sea, and assists crews in taking the correct actions to prevent collision For this reason, certain uncrewed vessels require the capability to display signal flags and day shapes in accordance with the International Code of Signals (ICS).

Day shapes are three-dimensional geometric shapes that visually communicate information about vessel navigation or the status of a ship. There are four basic three-dimensional shapes, which can be combined together to communicate different meanings: ball, cylinder, cone, diamond. There are many combinations of day shapes which are used to communicate different meanings.

Similarly, signal flags are also used to communicate at sea. These flags are two-dimensional, and can be used communicate several different meanings. According to the ICS, flags can convey meanings in the form of letters, numbers, as well as vessel status. The shape and silhouette of these flags is crucial to conveying the proper meaning; for example flags may be square, swallowtail, or pennant. As an example, according to the ICS, a square-shaped, pure yellow flag can be used to indicate the letter Q (Quebec) as part of a message, but when used alone can indicate “My vessel is healthy and I request free pratique.”

Uncrewed surface vessels (USVs) are vessels that can operate at sea, on the surface of the water, without a crew. Some USVs are operated remotely via satellite communication. For example, some USVs have a data connection to shore provided by satellite or terrestrial communications, with human operators directly controlling or supervising the vessel depending on the capabilities of the vessel and needs of the mission. USVs are of increasing commercial interest, and they have several potential areas of application including commercial shipping, environmental monitoring, offshore data acquisition, seafloor mapping to name a few. Because USVs do not require a crew, operations can be performed with fewer personnel exposed to offshore hazards and with a smaller environmental impact.

Typically, day shapes are physically hung from a mast, and signal flags are hoisted from flagpoles by crew members. However, this requires time, effort, and significant expertise and knowledge from crew members.

The applicant knows of a prior apparatus, described in Korean patent application KR20180125244 which describes a signal flag system for a ship. However, KR20180125244 is not concerned with USVs, and instead seeks to solve a different problem: that of requiring the crew members to memorise the various different flag codes and their meanings. The application discloses a controller which stores the flags and their meanings in a memory. The controller may also output signals to an LED screen, with the LED screen being capable of showing a representation of the flag, or symbol, in two-dimensions. However, this solution requires the LEDs to be on for long periods of time, with a high brightness to ensure good visibility, requiring considerable electrical power. Also, the LED representation of the flag can only be seen from a limited number of directions. The LED representation of a flag is also unable to display any shape of flag except a rectangle—such as swallowtail or pendant shapes. Filling in a section of the screen with black LEDs is not an optimal solution, because black is already used in some signal flags, and the outline (silhouette) of the flag is a key part of its communication. Also, this solution only works for two-dimensional flags, and cannot be adopted to indicate day shapes, which are three-dimensional geometric shapes.

The present invention seeks to address these and other disadvantages encountered in the prior art by providing an improved device for displaying maritime and nautical signals.

### SUMMARY

According to a first aspect of the present disclosure, there is provided a device for displaying nautical symbols on a vessel. The device comprises a first roller and a second roller. The first roller and the second roller are configured to support a banner. The banner comprises a plurality of symbols arranged for display lengthways along the banner. The first roller is configured to furl a first end of the banner and the second roller is configured to furl a second end of the banner such that a symbol in the plurality of symbols is positioned for display between the first roller and the second roller. The device further comprises an actuator configured to rotate at least one of the first roller and the second roller to thereby adjust which symbol in the plurality of symbols is positioned for display between the first roller and the second roller. The device also comprises a first processor configured to control the actuator. The first processor is configured to receive, from a second processor, a command comprising an indication to display a specific symbol of the plurality of symbols. The first processor is also configured to output, to the actuator, instructions to display the specific symbol. In some implementations, the device further comprises a display area, in which case a symbol may be considered to be positioned for display or displayed when that symbol is positioned within a display area of the device.

Optionally, the device is suitable for displaying nautical symbols on a vessel with a reduced crew and/or on an uncrewed vessel.

Optionally, the first processor is within a slave unit and the second processor is within a master unit.

Optionally, the command is received at the second processor from a remote controller.

Optionally, the device further comprises the banner. Alternatively, the banner may be provided as a distinct modular component that is separate from and removably affixed to the device.

Optionally, the banner comprises substantially opaque and substantially transparent parts. The substantially opaque and substantially transparent parts of the banner may define the symbols of the plurality of symbols. In some embodiments, the substantially opaque parts may be entirely opaque, and the substantially transparent parts may be entirely transparent. A substantially transparent material is a material with a higher transparency than a substantially opaque material. Similarly, a substantially opaque material is a material with a higher opacity and lower transparency than a substantially transparent material.

Optionally, the banner is two-sided. Here, the symbol positioned for display between the first roller and the second roller may be viewable from both sides of the banner.

Optionally, the plurality of symbols arranged for display lengthways along the banner may comprise a transparent symbol (or an empty symbol). A transparent symbol is a symbol which is entirely or mostly transparent or substantially transparent. For instance, the banner may comprise a transparent section which defines a transparent symbol in the plurality of symbols.

Optionally, the banner comprises a plurality of identifiers. Each identifier may be associated with a respective symbol in the plurality of symbols. Here, the device may further comprise a reader communicatively coupled to the first processor. The reader may be configured to: read an identifier associated with the symbol positioned for display between the first roller and the second roller; and communicate the identity of the symbol positioned for display between the first roller and the second roller to the first processor.

Optionally, each identifier in the plurality of identifiers is positioned along the banner such that, when a specific identifier is positioned within a readable range of the reader, the specific identifier's associated symbol may be displayed between the first and second rollers. Optionally still, the plurality of identifiers may comprise a plurality of RFID tags and the reader may be an RFID reader.

Optionally, the banner comprises a plurality of position control elements. Each position control element may be associated with a respective symbol in the plurality of symbols. The device may further comprise a position sensing mechanism. The position sensing mechanism may be configured to identify when the symbol positioned for display between the first roller and the second roller is displayed correctly by sensing the position control element associated with the symbol. The position sensing mechanism may further be configured to communicate that the symbol is displayed correctly between the first and second roller to the first processor. A symbol may be considered to be displayed correctly when the symbol is viewable from the device in an uncropped manner. Additionally or alternatively a symbol may be considered to be displayed correctly when it is centred, for example within a display window.

Optionally, the position sensing mechanism comprises a through-beam sensing mechanism. The through-beam sensing mechanism may comprise a transmitter and a receiver positioned either side of the banner. The transmitter may be configured to direct a beam toward the receiver. The receiver may be communicatively coupled with the first processor and configured to receive the beam of radiation. Each position control element in the plurality of position control elements may be positioned along the length of the banner such that the position sensing mechanism is configured to sense the position control element associated with the symbol by identifying when the position control element intersects the beam.

Optionally, the device further comprises at least one pole mount for mounting the device to the vessel. Optionally still, the at least one pole mount is configured to mount the device onto a flagpole. Alternatively, the at least one pole mount may be configured to mount the device onto the side of the ship, a mast or a different component of the vessel.

According to a second aspect of the present disclosure, there is provided apparatus for displaying a plurality of nautical symbols on a vessel. The apparatus comprises a plurality of devices, each according to the first aspect of the present disclosure. The devices of the plurality of devices are positioned with respect to one another on a support structure such that at least a subset of the displayed symbols displayed on each respective device can be viewed together to form a message. The support structure may be a flag pole, or the central flag pole or a vessel.

Optionally, the apparatus is suitable for displaying a plurality of nautical symbols on a vessel with a reduced crew and/or on an uncrewed vessel.

Optionally, the devices may be positioned adjacent to one another on the support structure. For instance, the devices may be planarly or linearly adjacent to one another on the support structure. Alternatively and optionally, each device in the plurality of devices may extend radially from a common central axis defined by the support structure.

Optionally, the devices in the plurality of devices may extend radially from the common central axis with a uniform angular distribution. Optionally still, each device may be independently controllable.

Optionally, the first processor of each device may be within a slave unit, and the second processor may be within a master unit configured to control the symbol displayed at each device.

Optionally, the master unit may comprise a computer-readable memory. In some implementations, the computer-readable memory may comprise an index of each symbol which may be displayed by each device and the order in which the symbols are arranged on each banner. Here, the master unit may be configured to: receive indications from the slave units regarding which symbols are currently being displayed, and store the currently displayed symbols in the computer-readable memory.

According to a third aspect of the present disclosure, there is provided a computer-implemented method of adjusting a displayed symbol on a device. The device comprises a first roller and a second roller. The first roller and the second roller are configured to support a banner. The banner comprises a plurality of symbols arranged for display lengthways along the banner. The first roller is configured to furl a first end of the banner and the second roller is configured to furl a second end of the banner such that a symbol in the plurality of symbols is positioned for display between the first roller and the second roller. The device further comprises an actuator configured to rotate at least one of the first roller and the second roller to thereby adjust which symbol in the plurality of symbols is positioned for display between the first roller and the second roller. The device further comprises a first processor configured to control the actuator. The method comprises receiving, at the first processor, from a second processor, a command comprising an indication to display a specific symbol in the plurality of symbols. The method further comprises outputting, to the actuator, instructions to display the specific symbol.

Optionally, the method further comprises, prior to receiving the command at the first processor, receiving, at a remote controller, a user input indicating the specific symbol to display; and sending, by the remote controller, to the second processor, the indication to display a specific symbol.

According to a fourth aspect of the present disclosure, there is provided a system. The system comprises a device for displaying nautical symbols on a vessel and a second processor. The device comprises a first roller and a second roller. The first roller and the second roller are configured to support a banner. The banner comprises a plurality of symbols arranged for display lengthways along the banner. The first roller is configured to furl a first end of the banner and the second roller is configured to furl a second end of the banner such that a symbol in the plurality of symbols is positioned for display between the first roller and the second roller. The device further comprises an actuator configured to rotate at least one of the first roller and the second roller to thereby adjust which symbol in the plurality of symbols is positioned for display between the first roller and the second roller. The device further comprises a first processor. The first processor is configured to receive, from the second processor, a command comprising an indication to display a specific symbol of the plurality of symbols. The first processor is further configured to output, to the actuator, instructions to display the specific symbol.

Optionally, the system further comprises a remote controller. The remote controller may be configured to receive a user input, the user input comprising an indication of the specific symbol to display. The remote controller may further be configured to send, to the second processor, the indication to display a specific symbol.

Optionally, the system further comprises a computer-readable memory coupled with the second processor. The computer-readable memory may comprise an index of each symbol which may be displayed by the device and the order in which the symbols are arranged on the banner. Here, the second processor may be configured to receive indications from the first processors regarding which symbol is currently being displayed. The second processor may further be configured to store the currently displayed symbols in the memory.

### BRIEF DESCRIPTION OF THE DRAWINGS

Specific implementations of the present disclosure are described below in the detailed description by way of example only and with reference to the accompanying drawings, in which:

FIG. 1 illustrates an exemplary device suitable for displaying nautical symbols on a vessel;

FIG. 2 illustrates an exemplary banner suitable for use within the device of FIG. 1;

FIG. 3 illustrates an apparatus for displaying three signal flags on a vessel;

FIG. 4 illustrates a perspective view of the rollers and banner of the device of FIG. 1;

FIG. 5 illustrates an example control system for the devices and apparatuses;

FIG. 6 is a flowchart of a method for adjusting a displayed symbol on a device;

FIG. 7 illustrates a specific implementation of the device of FIG. 1 suitable for displaying portions of day shapes on a vessel;

FIG. 8 illustrates a banner for use in the implementation of FIG. 7;

FIG. 9 illustrates an apparatus suitable for displaying day shapes on a vessel; and

FIG. 10 illustrates a computing device or unit.

Like reference numerals are used for like components throughout the drawings.

### DETAILED DESCRIPTION

In overview, and without limitation, the application discloses a device suitable for displaying nautical symbols on an uncrewed surface vessel (USV). The vessel need not be a USV, though this is a particularly beneficial implementation. Alternatively, the vessel may be a manned surface vessel with, for instance, a reduced crew size; or may be any vessel seeking to make more efficient use of the crew's time and resources. The device comprises a first and a second roller configured to support a banner therebetween, and the banner comprises a plurality of symbols for display along its length. These symbols might, for example, be signal flags or parts of a day shape. For instance, the banner may include 37 international flags and pennants (excluding the 3 substitute flags) as a continuous banner. Alternatively the banner may include a portions of a number of day shapes.

The banner is scrolled by rotation of one or both of the first and second rollers so as to display different symbols. Accordingly, the device comprises a first processor, which may be within or otherwise form part of a slave unit, capable of controlling rotation of one or both of the rollers so as to control which symbol is displayed between the rollers. The first processor is configured to receive signals from another, second processor, which may be within or otherwise form part of a master unit. The second processor, in turn, may receive signals from a remote controller—for example a remote controller positioned in a control centre and capable of communicating with the device via satellite communication. The remote controller is capable of sending instructions to the device (via the master unit) regarding which symbol should be displayed by the device, and, in turn, the first processor can control rotation of the first and/or second roller based on the instructions.

For the purpose of this document, flags, pennants and day shapes may be referred to as symbols for simplicity. It should also be understood that other symbols can be displayed by devices of the present application, and that devices of the present application are not limited to displaying remote flags or day shapes.

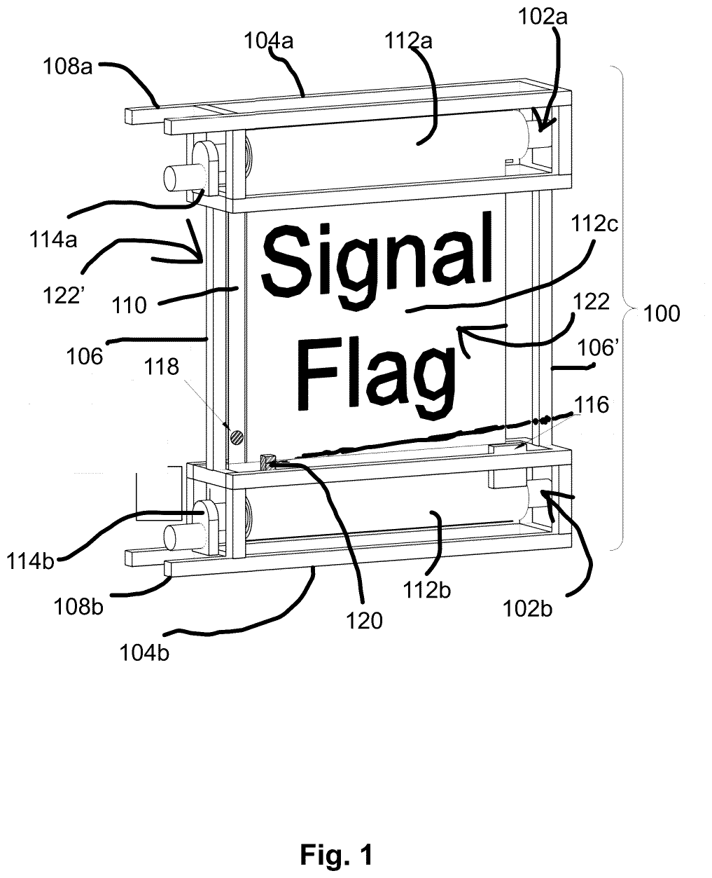

FIG. 1 depicts a device 100 suitable for displaying nautical symbols on a vessel, for example an uncrewed surface vessel. The device includes a first roller 102a, a second roller 102b, and a banner 110 comprising a plurality of symbols.

The first roller 102a is positioned at an opposite side of the device 100 to the second roller 102b. For instance, the first roller 102a may be positioned at the top of the device 100 and the second roller 102b may be positioned at the bottom of the device, as depicted in FIG. 1. Alternatively, the first roller 102a may be positioned at a lateral side of the device 100—e.g. the left or right side of the device—and the second roller 102b may be positioned at an opposing lateral side of the device 100—e.g. right or left side respectively. The rollers are configured to be rotated. The rollers are each attached to opposing ends of the banner 110. The rollers may be described as roller elements. The rollers may take the form of any physical component capable of and configured to rotate about an axis. For instance, the rollers may be mandrels.

Each roller may be housed within a roller housing 104a, 104b configured to secure the roller within the device 100. That is, the first roller 102a may be housed within a first roller housing 104a and the second roller 102b may be housed within a second roller housing 104b. The housings may take the form of a canister or other like structure. The first roller housing 104a and the second roller housing 104b are connected via a frame comprising support rods 106, 106′ extending from the first roller housing 104a to the second roller housing 104b, as depicted in FIG. 1. The frame and the support rods 106, 106′ are substantially rigid. The first roller housing 104a, second roller housing 104b and frame 106, 106′ may be fabricated together as a complete structure, or individually as interconnecting modular components.

The device additionally includes at least one pole mount. The device depicted in FIG. 1 comprises two pole mounts 108a, 108b. The pole mounts 108a, 108b are suitable for enabling the device to be mounted to a vessel, such as an uncrewed surface vessel. In particular, the pole mounts 108a, 108b may be configured to mount the device onto a support structure, for example a pole such as a flagpole, halliard, or a mast of a vessel. The support structure may be formed on the vessel itself. The pole mount 108a, 108b may be coupled to the first roller housing 104a, the second roller housing 104b and/or the frame 106, 106′. For instance, as depicted in FIG. 1, first roller housing 104a may comprise a first pole mount 108a and second roller housing 104b may comprise a second pole mount 108b. The pole mount(s) may be configured such that, when mounted to a pole, the device is suspended on the pole at a height and protrudes out perpendicular to the longitudinal axis of the pole. In this way, the device may be hoist up and presented on a flagpole in the same manner as a conventional flag, pennant, signal flag, and day shape.

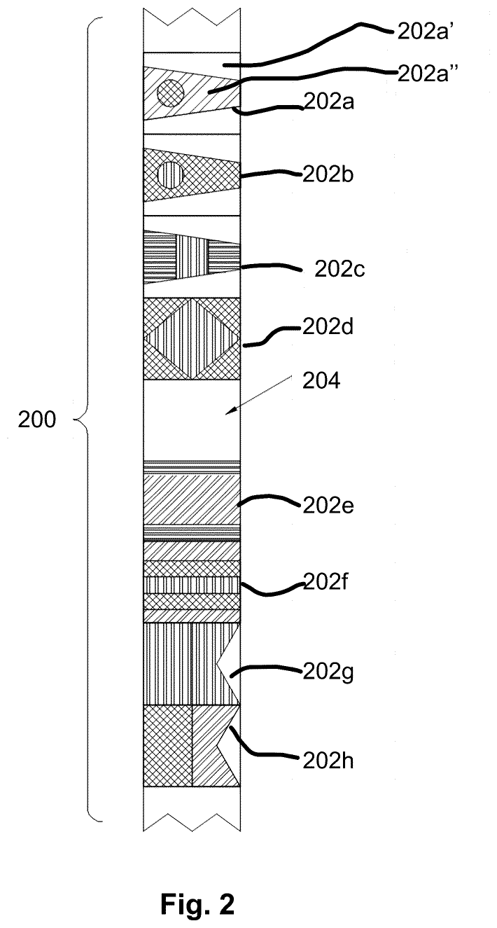

The device 100 further comprises a banner 110 which includes a plurality of symbols along its length. For example, the plurality of symbols may comprise signal flags or portions of day shapes. The banner 110 may be substantially rectangular, oblong, oval or stadium-shaped. Regardless of the exact shape, the banner nonetheless comprises a long (length) dimension and a short (width) dimension defining the banner's displayable plane. The long dimension may be at least an order of magnitude larger than the short dimension, which enables the plurality of symbols to be ordered linearly and sequentially in a lengthwise direction along the long dimension of the banner 110 such that, as the banner 110 scrolls through a display window, each symbol is sequentially displayed in the display window. The banner additionally has a thickness that is significantly smaller than the short dimension. The structure, configuration and layout of the banner 110 is described in more detail below in relation to FIG. 2.

Returning to FIG. 1, each dimension of the banner maps onto a dimension of the device 100. That is, the long dimension of the banner corresponds to the device's dimension which extends between the first roller 102a and the second roller 102b and the short dimension of the banner corresponds to the device's dimension which extends parallel to the axis of rotation of the first roller 102a and the second roller 102b. However, the long dimension of the banner is larger than corresponding dimension of the device 100 to allow the banner to comprise multiple symbols, where a portion of the long dimension of the banner can be furled around the rollers. Whereas, on the other hand, the short dimension of the banner is equal to or narrower than the corresponding dimension of the device 100.

The first roller 102a and the second roller 102b are positioned and configured within the device 100 to support the banner 110. As such, a first end 112a of the banner 110 is affixed to the first roller 102a and the second end 112b of the banner 110 is affixed to the second roller 102b. The banner 110 is wound, from its first end 112a, around the first roller 102a and, from its second end 112b, around the second roller 102b. An intermediate portion 112c of the banner is supported under tension in a display area 122 of the device 100 that is between the first roller 102a and the second roller 102b. This configuration is depicted in FIG. 1, where an intermediate portion 112c of the banner 110 depicting the exemplary words “Signal Flag” is supported and positioned for display in a display area 122 that is between the first roller 102a and the second roller 102b.

Accordingly, the device 100 described herein is beneficial over conventional flags (such as conventional signal flags) because the symbols appear to be flying regardless of the weather conditions. As such, unlike conventional flags, no amount of wind is required for the symbols to fly and no amount of rain can cause the device to droop. This is achieved, at least in part, by the rigidity imparted to the device by the rollers 102a, 102b, but additionally by the tension imparted to the banner 110 by the rollers 102a, 102b, the roller housings 104a, 104b, the frame 106, 106′, and the pole mounts 108a, 108b.

As depicted in FIG. 1, the banner 110 of the present disclosure may be two-sided, in which case the device includes a display area 122, 122′ on each side of the device. Each display area 122, 122′ provides a window through which one side of the banner 110 may be viewed such that the intermediate portion 112c of the banner is visible for display from both sides of the banner. Providing a display area 122, 122′ on each side of the device enables the symbols to be viewable on both sides—thus increasing the suitability for the device to replace conventional signal flags.

In most implementations, the banner 110 comprises a substantially transparent (or transparent, or translucent) sheet onto or into which a substantially opaque (or opaque, or translucent) material may be superimposed and/or overlaid to convey the shape of each symbol. A substantially transparent material will be understood to be a material with a higher transparency than a substantially opaque material. Similarly, a substantially opaque material will be understood to be a material with a higher opacity and lower transparency than a substantially transparent material. In an implementation, the areas of the banner are opaque and transparent and will be referred to as such throughout. Composing the banner in this manner allows the symbols to be viewable from both sides of the device-through both display areas 122, 122′. Comprising the banner of a transparent sheet obviates the need for any backlighting as natural light sources may illuminate the displayed symbol through either side. Additionally, comprising the banner of a transparent sheet enables the silhouette of the symbol to be visible, which is beneficial since the shape of a signal flag or day shape comprises information. The banner 110 may additionally comprise a transparent section (i.e. a section in which the opaque material is not superimposed), which provides a neutral, off, state for the device in which no symbol is displayed. This section is also referred to herein as an empty or transparent symbol.

The display area(s) 122, 122′ may be protected by a transparent window in an outer casing of the frame that is configured to reveal the display area(s)—and thus, the specific symbol displayed in the display area(s). Hence, the intermediate portion 112c of the banner 110 may be visible in the display area through the transparent window in the outer casing. The outer casing (including the transparent window) has an ingress protection rating suitable to preserve the banner 110 by shielding it from the harsh marine environment in which a USV may be deployed. Further, the outer casing may additionally comprise transparent or non-transparent sections around any other components of the device, such as the roller housings 104a, 104b. Alternatively, the other components of the device may have an ingress protection rating suitable to preserve the device 100 by shielding it from the harsh marine environment in which a USV may be deployed.

The configuration described herein enables the banner 110 to scroll through the display area so that each symbol along the length of the banner 110 can be sequentially positioned within the display area. In other words, the section of the banner 110 which comprises the intermediate portion 112c supported under tension in the display area 122, 122′ may change continuously. This continuous change is achieved by rotating the rollers 102a, 102b. For instance, rotating the first roller 102a acts to furl (or spool, wind or roll) the first end of the banner 112a and rotating the second roller 102b acts to furl (or spool, wind or roll) the second end of the banner 112a.

As will be apparent in light of the above, any reference herein to “furling” one end of the banner should also be read, where appropriate, to encompass “unfurling” one end of the banner and vice-versa. Equally, when a roller is describes as acting to “spool”, “wind” or “roll” the first end of the banner, it should be understood that the roller is also capable of the opposite and, where relevant, it should be read that the roller is also capable of “unspooling” “unwinding” or “unrolling” the first end of the banner. Similarly, it will be appreciated in light of the foregoing description that the first and second ends 112a, 112b of the banner 110 should not be interpreted as being strictly the peripheries of the banner 110, nor should those terms be interpreted as comprising fixed proportions of the banner extending out to the respective peripheries. Rather, the first and second ends 112a, 112b of the banner 110 refer to the variable proportions of the banner which are wound or furled around the first and second rollers 102a, 102b respectively. As such, the proportions of the banner 110 which comprise the first and second ends 112a 112b of the banner 110 are not fixed and continuously vary as the banner scrolls through the display area such that the first end 112a of the banner 110 increases in length as the second end 112a of the banner 110 decreases in length and vice-versa.

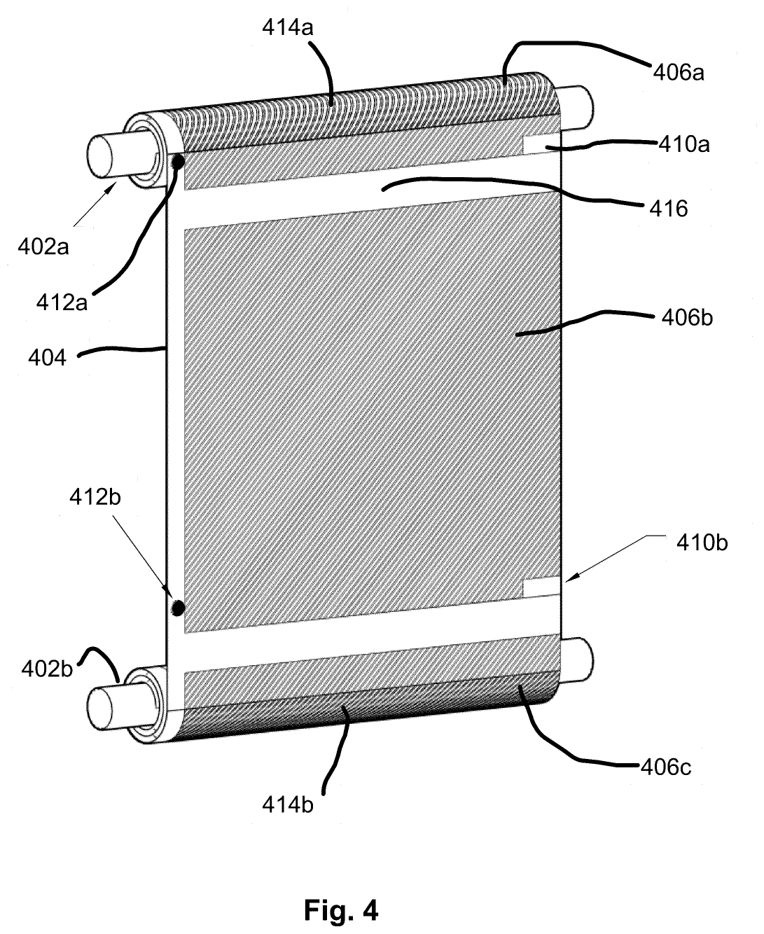

Therefore, as the banner scrolls through the display area, one of the rollers—e.g. the first roller 102a—may act as a discharge roller, unfurling the respective end of the banner 110. Simultaneously, the other roller acts as an intake roller, furling the other end of the banner 110. Thus, the rollers enable the banner to scroll from the discharge roller to the intake roller, through the display area 122, 122′ while maintaining tension in the intermediate portion 112c. The interaction of the banner with the rollers are further described in more detail in relation to FIG. 4.

Returning to FIG. 1, in some implementations, the device 100 may explicitly comprise the banner 110, in which case the banner 110 may be pre-installed into the device 100 and each end of the banner is permanently affixed to the rollers 102a, 102b. Providing the banner 110 explicitly within the device 100 enables increased structural reliability of the device, reduces manufacturing and operational complexities and obviates the requirement for indexing a new banner upon installation.

In alternative implementations, the banner 110 may be provided as a distinct modular component that is separate from the device 100. In these alternative implementations, the banner is removably affixed to the rollers 102a, 102b, such that the banner can be provided separately to and loaded into the device 100. In some of these alternate implementations easier loading of the banner 110 into the device 100 may be facilitated by configuring each roller 102a, 102b to be removable from its roller housing 104a, 104b such that the banner 110 may be affixed to the rollers 102a, 102b outside the device 100 and then installed into the device with the rollers 102a 102b. Providing the banner 110 as a distinct modular component that is separate from the device 100 enables more flexible use of the device as alternate banners may be temporarily installed into the device 100 and the banner(s) 110 can be removed from the device for maintenance and repair.

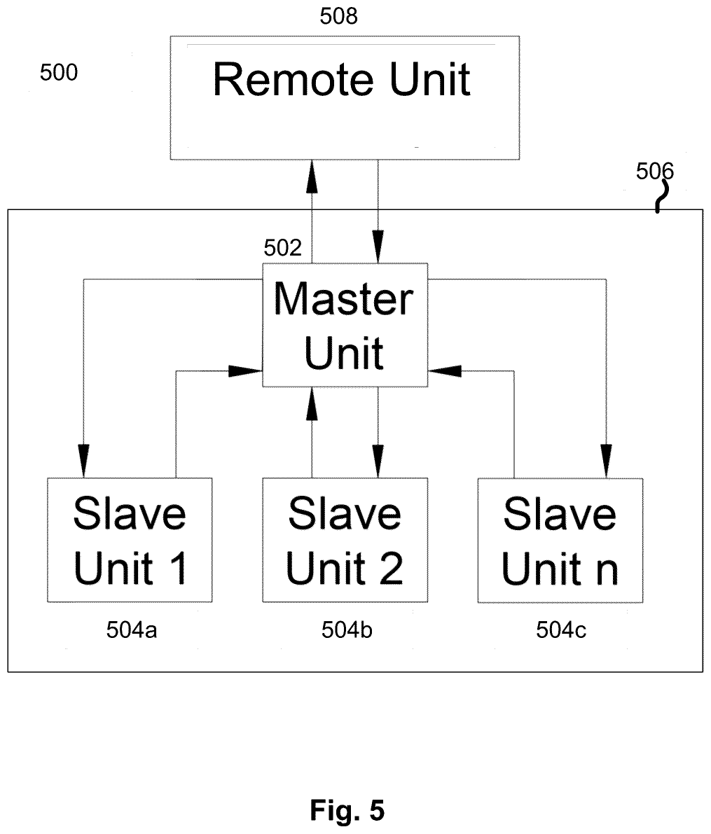

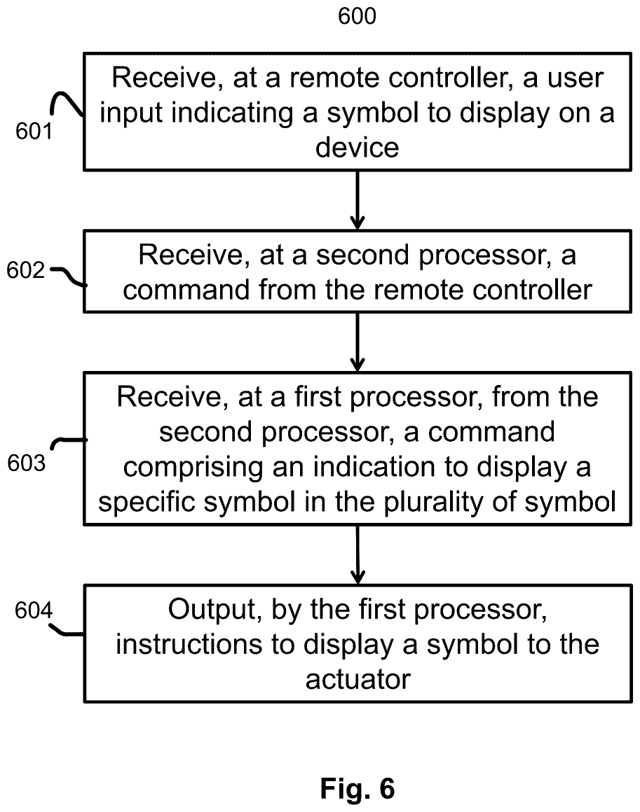

To actuate scrolling of the rollers 102a, 102b, at least one actuator 114a, 114b may be provided. The actuators are configured to actuate at least one of the rollers 102a, 102b. For instance, a first actuator 114a may be configured to rotate the first roller 102a and/or a second actuator 114b may be configured to rotate the second roller 102b. For example, the actuators may comprise motors. Each actuator within a given device may be in communication with a first processor of that device, which may be within a slave unit. In turn, each of the first processors across multiple devices may be in communication with a local second processor, for instance within a master unit, which may itself be in communication with a remote controller. In this way, each slave unit may be configured to receive instructions from the remote controller (via the second processor) and actuate the actuators 114a, 114b in accordance with those instructions. The operation of the actuators is described in more detail in relation to FIGS. 4 and 6 below. The architecture of the control system is described in more detail in relation to FIG. 5 below.

Returning to FIG. 1, when furled around either of the rollers 102a, 102b, the end of the banner may be up to a few centimetres (e.g. 5 cm) thick in radius. Therefore, in some circumstances, the radius of one end of the banner 112a, when furled around the roller 102a, may be impactfully different to the radius of the other end of the banner 112b when furled around the other roller 120b. For instance, this scenario may arise when the symbol at one extremity of the banner is displayed and therefore the length of banner 100 furled around one roller 102a may be significantly different from the length of banner 100 furled around the other roller 102b. As will be appreciated, when the radius of one end of the banner 112a around a roller 102a differs from the radius of the other end of the banner 112b around the other roller 102b, each roller must rotate at a different angular frequency to ensure that the intake rate of the banner 110 at the intake roller equals the discharge rate of the banner 110 at the discharge roller. If the intake rate of the banner 110 at the intake roller did not equal the discharge rate of the banner 110 of the discharge roller, the tension in the intermediate portion 112c may increase or decrease, which may cause the intermediate portion 112c of the banner to go slack or to tear. In order to rotate both rollers at the required angular frequencies respectively, one of the following two solutions may be implemented.

In one implementation, each roller is rolled at the required angular frequency by implementing a variable speed control. To this end, encoders may be coupled to the rollers 102a, 102b or their associated actuators to monitor each roller's respective angular velocities. Accordingly, the information recorded by the encoders may be used in proportional-integral-derivative (PID) control carried out by processors within the slave unit or the master unit. Such PID control is processed by the respective slave unit or the master unit to enable the desired rotation rate to be communicated with the actuators such that the rollers 102a, 102b are actuated at the desired relative angular velocities.

Alternatively, only the intake roller may be actuated, while the discharge roller is allowed to free-spin. This way, the intake roller acts to pull on the banner 110 when actuated, while the discharge roller may passively spin freely at the correct angular frequency in order to maintain tension in the banner. The discharge roller may comprise a resistance member in order to prevent the discharge roller over-spinning which would otherwise cause a loss in tension of the intermediate portion 112c of the banner.

The device 100 also includes mechanisms to ensure the symbols are positioned correctly (e.g. centred) in the display areas 122, 122′, without being cropped, and to identify and index which symbol is presently being displayed.

To identify which symbol is being displayed at any given time, the banner 110 may comprise a plurality of identifiers (not shown in FIG. 1). Each identifier is associated with a respective symbol on the banner and is configured to identify or otherwise index the respective symbol. That is, each identifier may, upon being read by a reader 116, return the identity (or a value representing the identity) of its respective symbol. The association and location of the identifier with the symbols on the banner is described in more detail with respect to FIG. 4.

Returning to FIG. 1, the device 100 includes a reader 116 communicatively coupled to the processor which actuates the actuator(s)—e.g. within the slave unit. The reader 116 is configured and positioned to read the identifier associated with the symbol presented on the intermediate portion 112c of the banner supported under tension in a display area 122, 122′ of the device 100. Thereby, the reader 120 is configured to read the identifier associated with the symbol. Upon reading the identifier associated with the symbol, the reader 120 communicates the identity or index of the displayed symbol to the slave unit. As such, the reader is tailored to the specific type of identifier (and/or vice-versa) such that the reader 120 is configured to read the identifiers. For instance, the identifier could include an RFID tag which encodes unique information for its associated symbol, such as an index number. In this case, the reader would comprise a RFID reader (e.g. a low frequency RFID reader). Alternatively, the identifier could comprise a magnetic stripe, in which case the reader comprises a magstripe reader.

The reader 116 is positioned within the device to align with the identifier. That is, the reader 116 is positioned such that, when an identifier is within a readable range of the reader, the symbol associated with that identifier is substantially present in the display area. In the implementation of FIG. 1, the reader 116 is positioned at the bottom right corner of the display area. As such, the reader 116 of FIG. 1 is configured to align with an identifier that is positioned at the bottom right corner of a symbol such that, when that bottom right corner of the symbol is aligned with the reader 116, the symbol is viewable in the display area. The reader may be attached to any structural component of the device, such as the second roller housing 104b, as depicted in FIG. 1.

The identification mechanism described herein enables the displayed symbol to be dynamically identified. Accordingly, the processors which communicate with the actuator(s) may more easily and accurately adjust the displayed symbol since, by dynamically identifying the displayed symbol, the identification of the displayed symbol can be fed back to the one or more processors or units which actuate the actuator(s). Furthermore, using RFID tags and an RFID reader has the additional benefit of reducing manufacturing and operation complexities, operational power requirements and operational costs.

To ensure that the banner is centred within the display area, the banner may include a plurality of position control elements 118, each of which is associated with a respective symbol. That is, each position control element 118 may provide a consistent positional reference point for each symbol to enable the banner 110 to be centred within the display area. For instance, each position control element 118 may comprise an opaque region in an otherwise transparent margin of the banner 110, positioned consistently relative to its associated symbol such that each position control element-symbol pair has the same positional relationship. The association and location of the position control elements 118 with the symbols is described in more detail with respect to FIG. 4 below.

Returning to FIG. 1, the device 100 includes a position sensing mechanism 120 capable of detecting when a symbol is positioned within a display area 122, 122′ between the first roller 102a and the second roller 102b. The position sensing mechanism 120 is communicatively coupled the processor which actuate the actuator(s)—e.g. within the slave unit—and is configured and positioned to detect when a symbol is positioned correctly within a display area 122, 122′. Accordingly, the position sensing mechanism can feed back to the processor information reflecting the position of the symbol in the display area 122, 122′. In the interest of reducing the bandwidth or processing power required, this information may be binary-reflecting that the symbol is either positioned correctly, or incorrectly, within the display area 122, 122′.

Much like the reader 116 and the identifier, the position sensing mechanism 120 is positioned within the device to align with the position control element 118. That is, the position sensing mechanism 120 is positioned such that, when a position control element 118 is aligned with the position sensing mechanism 120, the symbol associated with that position control element 118 is correctly positioned for display (for instance, in the center of the display area 122, 122′, where the symbol is not cropped). In the implementation of FIG. 1, the position sensing mechanism 120 is positioned at the bottom left corner of the display area. As such, the position sensing mechanism 120 of FIG. 1 is configured to align with a position control element 118 that is positioned at the bottom left corner of a symbol such that, when that bottom left corner of the symbol is aligned with the position sensing mechanism 120, the symbol is positioned correctly in the display area. The position sensing mechanism 120 may be attached to any structural component of the device, such as the second roller housing 104b, as depicted in FIG. 1.

In one exemplary implementation, the position sensing mechanism comprises a through-beam sensing mechanism. The through-beam sensing mechanism includes a transmitter and a receiver positioned either side of the banner, where the transmitter is configured to direct a beam of radiation (e.g. electromagnetic radiation) toward the receiver and the receiver is configured to detect receipt of that radiation. Accordingly, element 120 in FIG. 1 positioned at display area 122 in FIG. 1 may be a transmitter and a receiver may be positioned directly opposite at display area 122′. In this implementation, the position control element 118 may comprise a substantially opaque marker in an otherwise transparent margin of the banner 110 such that, when the position control element intersects the beam of radiation, the beam is prevented from propagating to the receiver which is indicative of the symbol being displayed correctly. Here, the marker and margin are opaque and transparent to the specific wavelength of the through-beam sensing mechanism's beam of radiation (which may not be in the visible spectrum) respectively. Accordingly, the receiver may communicate to the processor that the symbol is displayed correctly and, as such, the one or more processors may instruct the actuators to halt the rollers 102a, 102b.

The position sensing mechanism 120 described herein enables the one or more processors to accurately identify when the displayed symbol is positioned correctly. Accordingly, in combination with the identification mechanism described herein, the position sensing mechanism 120 enables the or more of the processors or units to communicate with the actuator(s) to accurately display the desired symbol. Furthermore, the above outlined through-beam sensing mechanism allows for a low cost, low power, and high accuracy position sensing mechanism 120.

It will be appreciated that alternative identifiers and position sensing mechanisms to those identified herein may be implemented within the device. Further, in some implementations, the functionality of both the identifier and the positioning sensing mechanism may be provided by a single means, which may further reduce the manufacturing and operational costs of the system.

The skilled person will understand that the device of FIG. 1 can be fabricated using known techniques. For instance, the display window and casing may comprise clear plastic or glass. Similarly, the frame, housing and rollers may comprise any suitable material such as wood or plastic. The casing is designed, manufactured and configured to be resistant to the expected conditions in a marine environment.

FIG. 2 depicts an example banner 200 which can be installed in, and is suitable for use with devices described herein, such as the device illustrated in FIG. 1. As illustrated, the banner 200 has a displayable plane which includes a plurality of sections or symbols. Each symbol 202a, 202b, 202c, 202d, 204, 202e, 202f, 202g, 202h is sequentially disposed along the banner's 200 length.

When the device is configured for use on a vessel, the symbols may represent international maritime signal flags or pennants. International maritime signal flags are distinguished by their coloured pattern and their shape. For instance, the signal flags may be square—such as symbols 202d, 202e, 202f, swallow-tailed—such as symbols 202g, 202h, or tapering-such as symbols 202a, 202b, 202c. Each flag may represent a different letter, number or message. Additionally, any number of flags (e.g. up to 3 flags) may be combined in a permutation which represents a code for a specific standardized message. Therefore, international maritime signal flags enable direct, analogue communication between vessels within eyesight of each other without requiring additional electronic communication means. For instance, each symbol in the banner 200 may represent one of the 26 signal flags that represent the 26 letters of the Latin alphabet, one of the 10 signal flags that represent the 10 Arabic numerals, the code/answer pennant, and a transparent symbol. Accordingly, 37 international symbols, signal flags or pennants, and the transparent symbol may be embodied by the continuous banner.

As depicted, each of the symbols have a shape which may be key to interpreting the meaning of the symbols. Accordingly, the symbols on the banner are configured to have shapes which are visible in silhouette. To this end, the symbols may be defined by comprising the banner of substantially transparent parts 202a″ and substantially opaque parts 202a′. For instance, symbol 202a may be defined by an opaque part 202a″ positioned within and superimposed on substantially transparent surrounding 202a′. Consequently, the tapering profile of symbol 202a is viewed in outline and is silhouetted when a light source is positioned behind the symbol, which allows symbol 202a's the physical shape to be communicated to an observer. The shapes of other symbols are communicated similarly. Comprising the banner of substantially transparent parts 202a″ and substantially opaque parts 202a′ ensures that the symbols can appear to be flying regardless of the weather conditions since the transparent parts 202a″ can function to maintain tensions across the opaque parts 202a′.

It should be appreciated that not all symbols need to comprise a substantially transparent part. For instance, some symbols (such as symbols 202d, 202e and 202f) may be substantially square and therefore need not be outlined by a substantially transparent part. In any case, the symbols may be demarcated by a substantially transparent surrounding (not shown in FIG. 2) in order to communicate the physical shape of the substantially square symbols to the observer.

Comprising the banner of substantially transparent parts 202a″ and substantially opaque parts 202a′ provides the additional benefit that the banner may comprise a transparent or empty symbol 204. The transparent symbol 204 may be a symbol which is purely transparent. In other words, the transparent symbol may be a symbol which is defined solely by a substantially transparent part 202a″ such that, when the transparent symbol is displayed in the display area of the device, no flag or pennant is show. This provides a neutral, off state for the device in which the vessel on which the device is installed is not signalling any message to other vessels. Importantly, the device need not be lowered from the flagpole or mast to which it is installed in this off state. Thus, providing a transparent or empty symbol 204 obviates the need to implement complex hoisting and lowering mechanisms for the device on the ship.

Furthermore, comprising the banner of substantially transparent parts 202a″ and substantially opaque parts 202a′ obviates the need to provide a backlight in the device as natural light can illuminate the banner from both sides in the same way as a conventional flag. Additionally, since the substrate is not opaque, the banner may be viewable from both sides.

To comprise the banner of substantially transparent parts 202a″ and substantially opaque parts 202a′, the banner may be formed by disposing opaque material representing each symbol's pennant onto a transparent sheet. The opaque material may be two-sided such that the printed graphics on the banner are visible on both sides of the single banner roll. Alternatively, the opaque material may be laminated on both sides by the transparent sheet. In either case, the method of manufacturing the banner comprises adhering opaque material representing each symbol's pennant onto the transparent sheet by any conventional durable adhesive means. In an example implementation, the opaque material may comprise nylon, polyester, or cotton and the transparent sheet may comprise a low-density polymer. Alternatively, or additionally, the opaque material may comprise an opaque ink and/or other opaque polymers.

As described in relation to FIG. 1 above, the banner may be substantially rectangular, oblong, oval or stadium-shaped and shaped to define a long dimension and a short dimension. The banner also has a thickness which is perpendicular to the long and short dimensions which is notably smaller than the short dimension. In one particular implementation, the long dimension of the banner measures up to approximately 30 meters and the short dimension measures approximately 1 meter. In this implementation, each symbol along the banner may measure 0.7 m by 0.9 m such that the banner, as a whole, may comprise 38 individual symbols.

According to the international code of signals, signal flags can be used to indicate single-letter signals—which represent very urgent, important or common messages; two-letter signals—for other messages; and three-letter signals beginning with “M”—which are the medical signal codes. In some cases additional characters are added to indicate quantities, bearing, course, distance, date, time, latitude, or longitude. As such, in order for the devices described herein to be suitable replacement for conventional signal flags, at least 3 devices may be provided.

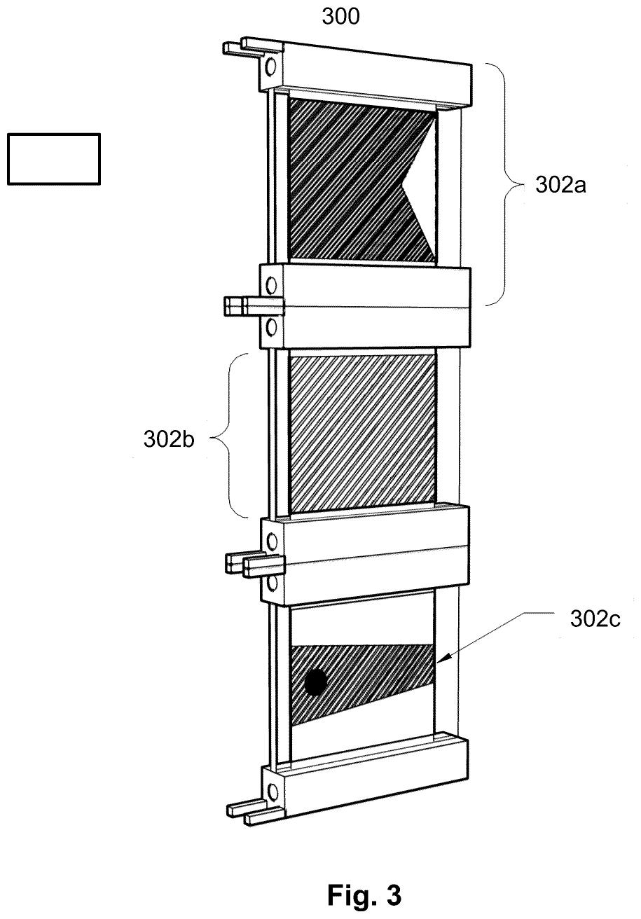

To that end, FIG. 3 depicts an example apparatus 300 for displaying a plurality of signal flags on an uncrewed surface vessel. The apparatus 300 comprises 3 devices 302a, 302b, 302c for displaying nautical symbols on an uncrewed surface vessel described herein. Each of the plurality of devices 302a, 302b, 302c is positioned with respect to one another on a support structure (not shown) such that at least a subset of the displayed symbols displayed on each respective device can be viewed together to form a message. Here, all of the displayed symbols can be viewed at the same time from either side of the apparatus 300. The devices 302a, 302b, 302c are positioned adjacent to one another such that, when the apparatus is hoisted up and presented on a flagpole, up to three signal flags can be displayed on the flagpole. In the implementation of FIG. 3, the devices 302a, 302b, 302c are positioned linearly adjacent with respect to one another. Each device in apparatus 300 is independently controllable. As each device is capable of displaying substantially any symbol, including a transparent symbol, apparatus 300 may be controlled to display any permutation of 1, 2, and 3 symbols.

FIG. 4 depicts a perspective view of the rollers and the banner of FIG. 1. FIG. 4 shows a first roller 402a, a second roller 402b, between which a banner 404 is supported. A first end of the banner 414a is furled around the first roller 402a and a second end of the banner 414b is furled around the second roller 402b. The banner 404, comprises a plurality of symbols 406a, 406b, 406c, each of which is associated with an identifier 410a, 410b and a position control element 412a, 412b.

As explained above, each identifier 410a, 410b is configured to identify or otherwise index the respective symbol when read by a reader. The identifiers 410a, 410b and their associated symbols 406a, 406b are positioned consistently such each identifier-symbol pair has the same positional relationship. In the implementation depicted on FIG. 4, each identifier is positioned in the bottom right corner of the symbol. This allows each identifier to be detectable by a fixed-position reader aligned with the bottom right corner. Upon reading the identifier, the reader may return a numeric value which corresponds to the symbol associated with the identify. The numeric value is returned to a first processor which relays it onto the second processor. The associations of each numeric value and symbol are stored in the memory of the second processor. Accordingly, the second processor, on receipt of the numeric value corresponding to the displayed symbol, can identify which symbol is associated with the numeric value and, thereby, determine which symbol is displayed. Equally, on receipt of a command to display a symbol on the device, the second processor can send to the first processor the numeric value associated with that symbol to display.

Position control elements 412a, 412b their associated symbols 406a, 406b are positioned consistently such each identifier-symbol pair has the same positional relationship. This allows each position control element to be detectable by a fixed-position sensing mechanism. In the implementation depicted on FIG. 4, each position control element is positioned in the left margin adjacent to the symbol. Upon sensing when the symbol associated with the specific position control element is displayed correctly between the first and second rollers, the position sensing mechanism returns a signal to signify the same. This signal is received by the first processor which may input the signal into a PID control in order to hold the symbol associated with the specific position control element in the display areas of the device. The first processor may also relay the signal onto the second processor.

The architecture of the computational control system including the first processor (e.g. within a slave unit) and the second processor (e.g. within a master unit) is described in more detail below with respect to FIG. 5.

Returning to FIG. 4, at least one of the first roller 402a and the second roller 402b are coupled to an actuator, configured to actuate rolling in the roller. For instance, the actuator may act to rotate at least one of the first roller 402a and the second roller 402b clockwise (as viewed from the FIG. 4's left side). As will be appreciated, rotating the first roller 402a and the second roller 402b clockwise causes the banner to scroll from the first roller 402a to the second roller 402b. Thus, the first roller 402a becomes the discharge roller and the second roller 402b becomes the intake roller.

Consequently, symbol 406b, initially positioned for display between the first roller and the second roller, scrolls towards the second roller 402b. Thereby, symbol 406b is assimilated into the second end of the banner 414b and is furled around the second roller 402b. Simultaneously, symbol 406a, initially positioned within the first end of the banner 414a and furled around the first roller 402a, is unfurled from the first roller 402a and scrolls into the display area between the first roller and the second roller.

Alternatively, the actuator may rotate at least one of the first roller 402a and the second roller 402b anti-clockwise (as viewed from the FIG. 4's left side). This causes the banner to scroll from the second roller 402b to the first roller 402a. Thus, the first roller 402a becomes the intake roller and the second roller 402b becomes the discharge roller.

Consequently, symbol 406b, initially positioned for display between the first roller and the second roller, scrolls towards the first roller 402a. Thereby, symbol 406b is assimilated into the first end of the banner 414a and is furled around the first roller 402a. Simultaneously, symbol 406c, initially positioned within the second end of the banner 414b and furled around the second roller 402b, is unfurled from the second roller 402b and scrolls into the display area between the first roller and the second roller.

FIG. 4 additionally depicts that the banner 404 may include, between each symbol 406a, 406b, 406c, a buffer 416. The buffer ensures that each symbol may be displayed singularly in the display area. Accordingly, the device does not appear to display more than the intended symbol.

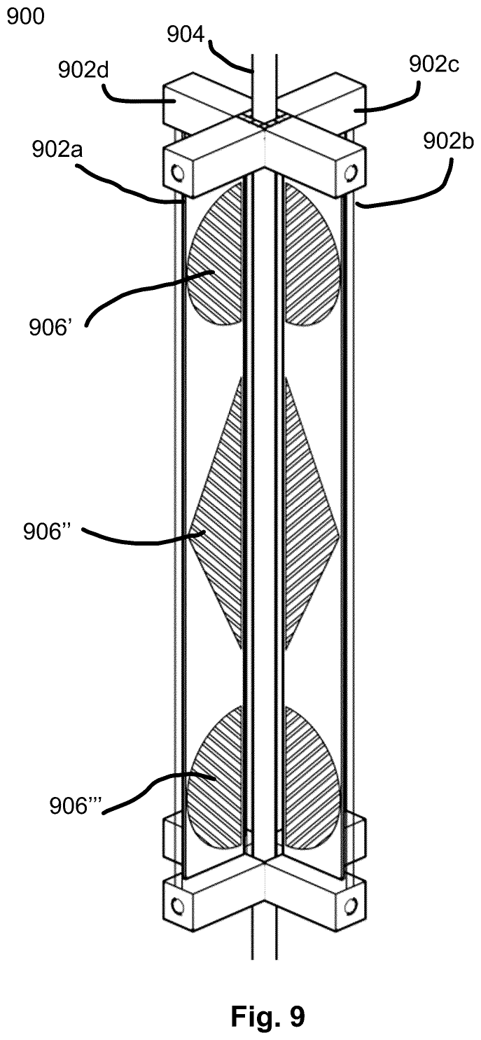

FIG. 5 depicts an example control system 500 to control the apparatuses and devices described herein. Each device comprises at least a first processor configured to receive instructions form, and to communicate with, a second processor. In an implementation of the present disclosure, each first processor is a slave processor within a slave unit, and the second processor is a master processor within a master unit. The system 500 shown in FIG. 5 includes a master unit 502 and a plurality of slave units 504a, 504b and 504c. The master unit 502 is local to an apparatus 506 which comprises the plurality of slave units 504a, 504b and 504c. For instance, the master unit 502 may be disposed on the same vessel as the apparatus 506. Example apparatus are described in relation to FIG. 3 and FIG. 9. The system 500 further comprises a remote processor within a remote controller or remote unit 508, which is remote from (i.e. not local to) the apparatus 506. The terms “remote controller” and “remote unit”, as referred to herein, may be used interchangeably. The apparatus 506 may be installed on a complex system (such as an uncrewed surface vessel, reduced-crew surface vessel, or any other vessel).

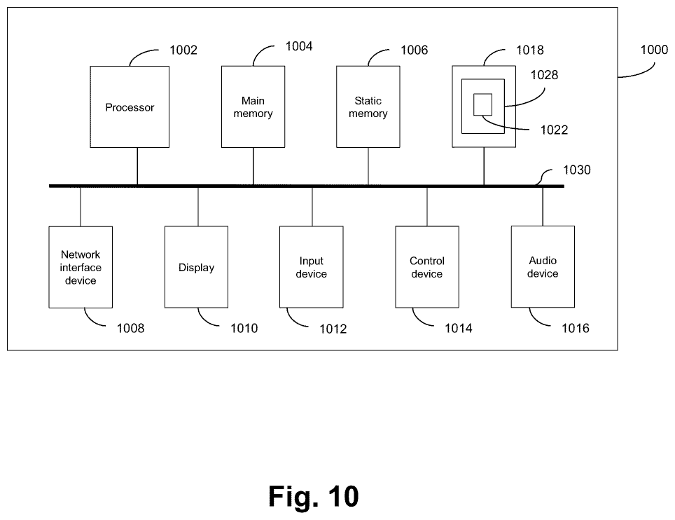

Here, the remote unit 508 may also be at the complex system, or the remote unit 508 may be away from the complex system—e.g. in a control room at a port. This architecture allows a user to remotely control devices and apparatuses comprising a plurality of devices, e.g. from the vessel's control room or from a control room on-land. Each slave unit 504a, 504b, 504c, the master unit 502, and the remote unit 508 comprise at least a processor, a computer readable memory, and a means for communicatively coupling to other units. The remote unit may further comprise, an input mechanism—e.g. a keyboard, an output mechanism—e.g. a screen. The remote unit's input mechanism may comprise a human-machine interface. The structures of the units are described in more detail below with respect to FIG. 10.

Returning to FIG. 5, the computational system 500 could additionally include a common central controller (not depicted) communicatively coupled to a plurality of master units. In this implementation, each master unit is local to a single vessel within a fleet and the common controller is bi-directionally, communicatively coupled to all of the master units. Additionally, the common controller is, bi-directionally, communicatively coupled to and can interface with the remote unit. Accordingly, this implementation enables the remote unit to remotely coordinate and control devices and apparatuses on multiple ships in the same fleet from the remote unit in a control room at a port.

Each slave unit 504a, 504b, 504c is configured to control an associated device. FIG. 5 depicts 3 slave units, slave unit 1 504a, slave unit 2 504b, and slave unit 504c. Therefore the implementation of FIG. 5 is suitable for controlling an apparatus comprising 3 devices. However, 4 or more (or fewer) slave units may be present to control an apparatus including 4 or more (or fewer) devices accordingly. The slave units are, bi-directionally, communicatively coupled with the master unit 502 local to a common apparatus 506. Accordingly, the slave units are configured to communicate information to the master unit 502—such as information output from the reader, the position sensing mechanism, the encoders, and the actuators. Similarly, the slave units are configured to receive information—such as the index of a symbol for display—and commands-such as a command to display a specific symbol—from the master unit 502.

The master unit 502 is communicatively coupled to the remote unit 508. Accordingly, the master unit 502 is configured to communicate information to the remote unit 508—such as the identity of the symbol currently displayed on each device. Similarly, the master unit is configured to receive a command from the remote unit 508—such as a command to display a specific symbol—and translate that command to the respective slave units. For instance, the command may indicate: symbol A to be displayed on the device associated with slave unit 1 504a, symbol B to be displayed on the device associated with slave unit 2 504b, and symbol C to be displayed on the device associated with slave unit n 504c. Accordingly, the master unit may send a command to display symbol A to slave unit 1 504a, a command to display symbol B to slave unit 2 504b, and a command to display symbol C to slave unit n 504c.

The remote unit 508 comprises at least an input, which may take the form of a human-machine interface (HMI). As such, the remote unit 508 is configured to receive an input indicating that a specific symbol is to be displayed on a device, or that a specific message (i.e. multiple specific symbols) should be spelled out across the multiple devices of an apparatus. The remote unit 508 is then configured to generate a command corresponding to this input and communicate that command to the master unit 502, which in turn translates the command to the slave units 504a, 504b, 504c.

The master unit 502 comprises a memory. The master unit's 502 memory stores a directory of the plurality of symbols on the associated devices and the associated indices of each symbol in the plurality of symbols. Accordingly, when the master unit 502 translates a command from the remote unit 508 to the slave units 504a, 504b, 504c, the master unit 502 may first access the directory to identify the indices which is associated with the symbols in the command, and then the master unit 502 may send, each index to a respective slave units 504a, 504b, 504c.

The slave units 504a, 504b, 504c, are configured to control the various electronic components of a respective devices. Hence, each slave unit 504a, 504b, 504c is communicatively coupled to the at least one actuators, encoders, reader and position sensing mechanism of its respective device.

Primarily, a slave unit is configured to coordinate the actuation of the rollers. To achieve this, each slave unit controls the at least one actuators by outputting instructions to the actuators which indicate the speed, direction and duration of actuation. Duration of actuation may be indicated by duration of instructions outputted to the actuators.

Speed of actuation may depend on the specific implementation of the device. If a variable speed control is implemented at each roller in order to ensure that each rollers rotates at a desired angular frequency, the instructed speed may be calculated as a function of the offset between the center of the banner and the portion of the banner in the display area. The offset is calculated by the slave unit or the master unit 502 by comparing the index of the displayed symbol with a directory containing the identity of the symbol at the center of the banner. Accordingly, if the offset is large, then the difference in angular velocity between each roller must also be large. Similarly, if the center of the banner is substantially in the display area, then each roller may rotate at the same angular velocity. Alternatively, if only the intake roller is actuated, the rollers may rotate at a predetermined speed.

The speed of actuation is further monitored and controlled by encoders attached to the end of the rollers. The encoders monitor each roller's respective angular velocity and feed the roller's respective angular velocities back to the slave unit. Accordingly, the speed of actuation can be fine tuned by the slave unit though proportional-integral-derivative (PID) control based on the roller's respective angular velocities.

Fine tuning by PID control may also be based on signals received the reader and the position sensing mechanism. The position sensing mechanism communicates to the slave unit when a symbol is displayed correctly (e.g. centred) between the first and second rollers. Accordingly, the position sensing mechanism effectively communicates a target position for the rollers to the slave unit. This target position is used in the PID calculations to ensure that the symbol is displayed correctly between the first and second rollers. Similarly, the reader communicates to the slave unit the identity (or an index associated with the identity) of the symbol which is displayed, or closest to being displayed, between the first and second rollers.

Accordingly, the reader enables the slave unit to dynamically monitor the identity of the symbol positioned for display and thereby, adjust the instructions output to the actuators accordingly.

Direction of actuation is indicated to the actuators based on a command to display a specific symbol and the location of that specific symbol in relation to the currently displayed symbol. For instance, if the specific symbol is furled at the first end of the banner, the actuators are actuated such that the first end of the banner is unfurled, and the specific symbol is scrolled to the display area. Similarly, if the specific symbol is furled at the second end of the banner, the actuators are actuated such that the second end of the banner is unfurled, and the specific symbol is scrolled to the display area.

Similarly, duration of actuation is indicated to the actuators based on the command to display a specific symbol in the display area and the distance between that specific symbol and the currently displayed symbol. For instance, if symbol A is currently being displayed and the slave unit receives a command to display symbol B, where symbols A and B are separated by symbol C, the slave unit will output instructions to the actuators to rotate the rollers for the duration necessary to pass from symbol A, over symbol C and stop on symbol B. Alternatively, if symbols A and B are adjacent to each other, the slave unit will output instructions to the actuators to rotate the rollers for the duration necessary to pass from symbol A and stop on symbol B.

As described herein, any control, instruction, command, indication or communication interfaced between any computational units may be embodied by any suitable computational communication method, such as wired communication or wireless communication. Wired communication methods include local area network (LAN) connections and wireless communication methods include Wi-Fi or other satellite communication means. For instance, the master unit 502 may be communicatively coupled to the slave units 504a, 504b, 504c, via a LAN as these units are all local to the apparatus 506. However, the master unit 502, may be connected to the remote unit 508 via satellite communication since the remote unit 508 is not necessarily local to the master unit 502.

Further, any communicative coupling between a slave unit and an electronic component comprises any conventional mechanism through which the electronic component is controlled. For instance, the actuator may be controlled by inputs indicating a desired speed, direction and duration of actuation, in which case the slave unit may indicate to the actuator a speed, direction and duration of actuation.

The control system 500 described herein has the benefit of enabling display signal flags and day shapes in accordance with the International Code of Signal be remotely controlled in an uncrewed (or reduced-crew) surface vessel. In particular, by locating a master unit 502 and multiple slave units 504a, 504b, 504c at an apparatus 506 and communicatively coupling the master unit with a remote unit 508, each device in the apparatus may be controlled remotely—e.g. at a port-via the remote unit. This architecture has the additional benefit that one user may control multiple apparatuses from the same remote unit.

FIG. 6 depicts an exemplary flowchart depicting a method 600 of adjusting a displayed symbol on a device. The method starts at step 601 where a user input is received at a remote controller. The user input may take the form of a selection on a human-machine interface at the remote controller-such as a click of a mouse. The user input indicates which symbol to display on a device, or which symbols to display on an apparatus comprising a plurality of devices.

Next, at step 602, a second processor receives a command from the remote controller. The command represents the user input received at step 601. That is, the command indicates to the second processor which symbol to display on a device, or which symbols to display on an apparatus comprising multiple devices.

The method continues at step 603, where the first processor receives, from the second processor, a command comprising an indication to display a specific symbol. The specific symbol corresponds to the symbol indicated from the remote controller to the second processor. The command may indicate an index of the specific symbol to be displayed to the first processor. That is, the command is a translation of the command sent from the remote controller to the second processor at section 602 because the command at step 603 essentially represents the same information. If multiple symbols are to be displayed on an apparatus comprising multiple devices, then it should be appreciated that each first processor on each of the devices may receive, in parallel, from the second processor, a command comprising an indication to display a specific symbol in the plurality of symbols at step 603.

Responsive to receiving the command at step 603, the first processor, at step 604, outputs instructions to display the specific symbol to the actuator. These instructions are based on the index indicated from the second processor to the first processor at step 602. Next, the actuator, responsive to receiving instructions from the first processor, is actuated accordingly such that the specific symbol is displayed on the device associated with the first processor.

In an implementation of the above outlined method, the second processor may be within, or otherwise from part of, a master unit and the first processor may be within, or otherwise form part of, a slave unit.

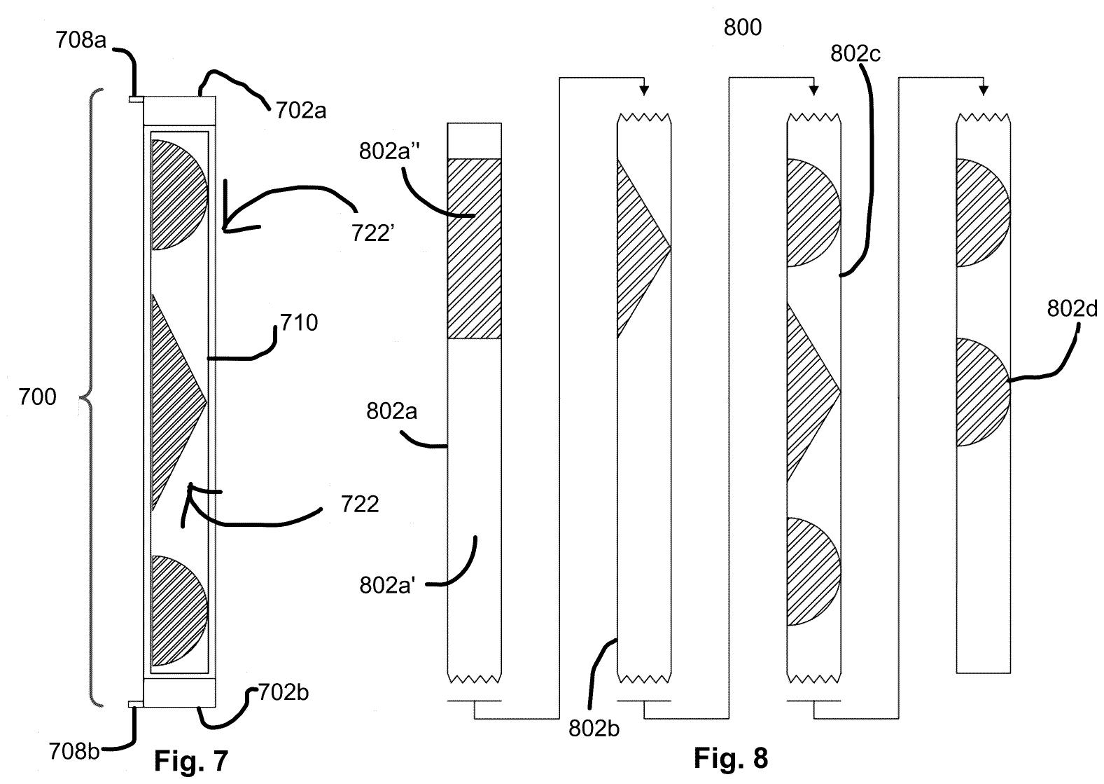

FIGS. 7-9 depict an alternative implementation of the device, banner and apparatus described herein which are suitable for displaying day shapes or representations thereof. Day shapes are mast head signals visually indicating the status of a vessel to other vessels on navigable waters during daylight hours. The signals constitute a set of three-dimensional geometric shapes-sphere, cylinder, cone, and diamond—that are usually hung from a mast of a vessel. For instance, a single cone may signal that the vessel is under sail and power, a single ball may signal that the vessel is anchored, three balls in a vertical line may signal that the vessel is aground, and a diamond may signal that a vessel is towing or being towed.

Accordingly, FIG. 7 depicts a device 700 in an alternative implementation to the device 100 of FIG. 1. Device 700 may be substantially the same as the device of FIG. 1 in almost all respects and any like components may be configured similarly. That is, device 700 comprises a first roller and a send roller which may be housed within a first roller housing 704a and a second roller housing 704b respectively. Device 700 may further comprise at least one pole mount 708a, 708b suitable for mounting the device to a pole. Additionally, device 700 further comprises a banner 710 which includes a plurality of symbols along its length. Like the banner 110 of FIG. 1, banner 710 of FIG. 7 is supported by the first roller and the second roller. That is, a first end of banner 710 is affixed to, and wound around, the first roller and a second end of banner 710 is affixed to, and wound around, the second roller. Accordingly, an intermediate portion of the banner is supported under tension in a display area 722 of the device 700 that is between the first roller and the second roller. Device 700 includes a display area 722, 722′ on each side of the device and the banner 710 is two-sided.

It is noted that device 700 of FIG. 7 additionally includes a position sensing mechanism and a reader equivalent to those of device 100 in FIG. 1. Accordingly, banner 710 of FIG. 7 includes a plurality of identifiers and a position control element equivalent to those of banner 110 of FIG. 1 and banner 404 of FIG. 4. However, these elements are not depicted in FIG. 7 for convenience.

Unlikely the implementation of the device depicted in FIG. 1, the symbols on banner 710 comprise two-dimensional projections of day shape portions. Portions of up to three day shapes may be comprised within a single symbol. Symbols comprising two-dimensional projections of day shape portions have different dimensions to symbols representing signal flags. As such, device 700 may have different proportions to the device 100 depicted in FIG. 1. In particular, the day shape symbols are longer than the signal flag symbols and therefore device 700 has an elongated midsection which facilitates an elongated display area 722, 722′ as compared to device 100. That is, device 700 may comprise a larger long dimension compared to device 100. Similarly, banner 710 may comprise a larger long dimension compared to banner 110.

Further, the banner 710 installed into device 700 of FIG. 7 is different to banner 110 installed into device 100 of FIG. 1, banner 200 of FIG. 2, or banner 404 of FIG. 4. FIG. 8 depicts an example banner 800 which may be suitable for use with device 700 of FIG. 7.

The banner 800 of FIG. 8 gives 4 example symbols 802a, 802b, 802c, 802d, each of which comprises a set of two-dimensional projections of day shape portions. Symbol 802a comprises a two-dimensional projection of a portion of a cylinder in the top position, symbol 802b comprises a two-dimensional projection of a portion of a diamond in the top position, symbol 802c comprises two-dimensional projections of a portion of a ball in the top and bottom positions and a two-dimensional projection of a portion of a diamond in the middle position, and symbol 802b comprises two-dimensional projections of a portion of a ball in the top and middle positions. The banner 800 may additionally include more symbols, each of which comprises a set of two-dimensional projections of day shape portions. For example, the banner may allow for 6 signals (combinations consisting of cylinders, diamonds, and balls) and a transparent or empty symbol to be displayed.

Similarly to the other banners described herein, banner 800 comprises a long dimension and a short dimension and a thickness. However banner 800's long dimension may be longer to accommodate for the longer symbols. The arrows depicted in FIG. 8 illustrate the continuous progression of each symbol on banner 800. As such, each symbol on banner 800 is displayed linearly and sequentially in a lengthwise direction along the long dimension of the banner.

Further, similarly to the other banners described herein, symbols 802a, 802b, 802c, 802d of banner 800 are defined by comprising the banner of substantially transparent parts 802a′ and substantially opaque parts 802a″. This provides the same benefits as described in relation to other implementations herein. Similarly, banner 800 may additionally comprise a transparent or empty symbol which, when displayed in the display area of the device, allows no day shape to be shown without requiring complex hoisting and lowering mechanisms for the device on the ship.

Device 700 and banner 800 may be fabricated in the same way as any of the other banners described herein.

FIG. 9 depicts an example apparatus 900 for displaying day shapes on an uncrewed surface vessel. The apparatus 900 comprises a plurality of devices 902a-d positioned with respect to one another on a support structure 904 such that at least a subset of the displayed symbols displayed on each respective device 902a-d can be viewed together to form a message. Here, at least two of the displayed symbols can be viewed at the same time any angle around the apparatus 900. The apparatus 900 includes 4 of the devices of FIGS. 7, 902a, 902b, 902c, and 902d. Each device 902a, 902b, 902c, and 902d extends radially from a central axis 904 which is common to the other devices 902a, 902b, 902c, and 902d. As depicted in FIG. 9, the common central axis 904 may be defined by a support structure, which may be a pole or a mast, to which each device 902a, 902b, 902c, and 902d is attached and from which each device 902a, 902b, 902c, and 902d extends radially.

Accordingly, the apparatus 900 of FIG. 9 presents, to an external observer (for instance, a person on a nearby vessel), a two-dimensional projection of three-dimensional day shapes. For instance, in the implementation depicted in FIG. 9, two-dimensional projections of three day shapes are presented: two-dimensional projections of a ball are presented in the top 906′ and bottom 906″ positions, and a two-dimensional projection of a diamond is presented in the middle position 906″.

As each device 902a, 902b, 902c, and 902d extends radially from a central axis 904 and each device 902a, 902b, 902c, and 902d is two-sided, the two-dimensional projection of three-dimensional day shapes are omnidirectional. This is similar to conventional three-dimensional day shapes. Accordingly the two-dimensional projections 906′, 906″, and 906″ are presented simultaneously to multiple external observers at different angular positions relative to apparatus 900—much like conventional day shapes. In some implementations, to support this omnidirectionality, the devices 902a, 902b, 902c, and 902d may extend radially from the common central axis at a uniform angular distribution.

Moreover, as the two-dimensional projections are comprised by transparent and opaque parts, their silhouettes can be visible, as is the case with conventional three-dimensional day shapes. As such, the apparatus 900 may be a direct replacement for conventional day shapes, without requiring manual effort to adjust. Accordingly, apparatus 900 provides a convenient apparatus for presenting and updated day shapes on uncrewed, or reduced-crew, surface vessels.

The control methods and computational units described herein may be embodied on a computer-readable medium, which may be a non-transitory computer-readable medium. The computer-readable medium carrying computer-readable instructions arranged for execution upon a processor so as to make the processor carry out any or all of the methods described herein.

The term “computer-readable medium” as used herein refers to any medium that stores data and/or instructions for causing a processor to operate in a specific manner. Such storage medium may comprise non-volatile media and/or volatile media. Non-volatile media may include, for example, optical or magnetic disks. Volatile media may include dynamic memory. Exemplary forms of storage medium include, a floppy disk, a flexible disk, a hard disk, a solid-state drive, a magnetic tape, or any other magnetic data storage medium, a CD-ROM, any other optical data storage medium, any physical medium with one or more patterns of holes, a RAM, a PROM, an EPROM, a FLASH-EPROM, NVRAM, and any other memory chip or cartridge.

FIG. 10 illustrates a block diagram of one implementation of a computing device 1000 within which a set of instructions, for causing the computing device to perform any one or more of the methodologies discussed herein, may be executed. The computing device 1000 could embody comprise any of the master unit, slave unit, remote unit or common central controller described herein and, in particular, with reference to FIG. 5. Each of the master unit, slave unit, remote unit or common central may be connected (e.g., networked) to one another in a Local Area Network (LAN), an intranet, an extranet, or the Internet.

The computing device 1000 may operate in the capacity of a server or a client machine in a client-server network environment, or as a peer machine in a peer-to-peer (or distributed) network environment. The computing device may be a personal computer (PC), a tablet computer, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single computing device is illustrated, the term “computing device” shall also be taken to include any collection of machines (e.g., computers) that individually or jointly execute a set (or multiple sets) of instructions to perform any one or more of the methodologies discussed herein.

The example computing device 1000 includes a processor 1002, a main memory 1004 (e.g., read-only memory (ROM), flash memory, dynamic random-access memory (DRAM) such as synchronous DRAM (SDRAM) or Rambus DRAM (RDRAM), etc.), a static memory 1006 (e.g., flash memory, static random-access memory (SRAM), etc.), and a secondary memory (e.g., a data storage device 1018), which communicate with each other via a bus 1030.

Processing device 1002 represents one or more general-purpose processors such as a microprocessor, central processing unit, or the like. More particularly, the processing device 1002 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 1002 may also be one or more special-purpose processing devices such as an application specific integrated circuit (ASIC), a field programmable gate array (FPGA), a digital signal processor (DSP), network processor, or the like. Processing device 1002 is configured to execute the processing logic (instructions 1022) for performing the operations and steps discussed herein.

The computing device 1000 may further include a network interface device 1008. The computing device 1000 also may include a video display unit 1010 (e.g., a liquid crystal display (LCD) or a cathode ray tube (CRT)), an alphanumeric input device 1012 (e.g., a keyboard or touchscreen), a cursor control device 1014 (e.g., a mouse or touchscreen), and an audio device 1016 (e.g., a speaker). Combinations of these components may be embodied as a human-machine interface.

The data storage device 1018 may include one or more machine-readable storage media (or more specifically one or more non-transitory computer-readable storage media) 1028 on which is stored one or more sets of instructions 1022 embodying any one or more of the methodologies or functions described herein. The instructions 1022 may also reside, completely or at least partially, within the main memory 1004 and/or within the processing device 1002 during execution thereof by the computer system 1000, the main memory 1004 and the processing device 1002 also constituting computer-readable storage media.

The various methods described above may be implemented by a computer program. The computer program may include computer code arranged to instruct a computer to perform the functions of one or more of the various methods described above. The computer program and/or the code for performing such methods may be provided to an apparatus, such as a computer, on one or more computer readable media or, more generally, a computer program product. The computer readable media may be transitory or non-transitory. The one or more computer readable media could be, for example, an electronic, magnetic, optical, electromagnetic, infrared, or semiconductor system, or a propagation medium for data transmission, for example for downloading the code over the Internet. Alternatively, the one or more computer readable media could take the form of one or more physical computer readable media such as semiconductor or solid-state memory, magnetic tape, a removable computer diskette, a random-access memory (RAM), a read-only memory (ROM), a rigid magnetic disc, and an optical disk, such as a CD-ROM, CD-R/W or DVD.

In an implementation, the modules, components and other features described herein can be implemented as discrete components or integrated in the functionality of hardware components such as ASICS, FPGAs, DSPs or similar devices.

A “hardware component” is a tangible (e.g., non-transitory) physical component (e.g., a set of one or more processors) capable of performing certain operations and may be configured or arranged in a certain physical manner. A hardware component may include dedicated circuitry or logic that is permanently configured to perform certain operations. A hardware component may be or include a special-purpose processor, such as a field programmable gate array (FPGA) or an ASIC. A hardware component may also include programmable logic or circuitry that is temporarily configured by software to perform certain operations.

Accordingly, the phrase “hardware component” should be understood to encompass a tangible entity that may be physically constructed, permanently configured (e.g., hardwired), or temporarily configured (e.g., programmed) to operate in a certain manner or to perform certain operations described herein.

In addition, the modules and components can be implemented as firmware or functional circuitry within hardware devices. Further, the modules and components can be implemented in any combination of hardware devices and software components, or only in software (e.g., code stored or otherwise embodied in a machine-readable medium or in a transmission medium).

Unless specifically stated otherwise, as apparent from the following discussion, it is appreciated that throughout the description, discussions utilizing terms such as “receiving”, “determining”, “comparing”, “enabling”, “maintaining”, “identifying”, “commanding”, “indicating”, “outputting”, “instructing”, or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

It will be understood that certain terminology is used in the preceding description for convenience and is not limiting. The terms “a”, “an” and “the” should be read as meaning “at least one” unless otherwise specified. The term “comprising” will be understood to mean “including but not limited to” such that systems or method comprising a particular feature or step are not limited to only those features or steps listed but may also comprise features or steps not listed. Equally, terms such as “over”, “under”, “front”, “back”, “right”, “left”, “top”, “bottom”, “side”, “clockwise”, “anti-clockwise” and so on are used for convenience in interpreting the drawings and are not to be construed as limiting.

Reference is made herein to devices, systems and methods suitable for use with or on a vessel. While implementations in which the vessel has a reduced crew, or is uncrewed entirely, are particularly advantageous, it will be understood by the skilled person that the presently disclosed device(s), apparatus(es), system(s) and method(s) may be used in conjunction with any vessel, including fully crewed vessels. As an example, the vessel may be an uncrewed surface vessel.

The above description is intended to be illustrative, and not restrictive. Many other implementations will be apparent to those of skill in the art upon reading and understanding the above description. Although the present disclosure has been described with reference to specific example implementations, it will be recognized that the disclosure is not limited to the implementations described, but can be practiced with modification and alteration within the spirit and scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

1. A device for displaying nautical symbols on a vessel, the device comprising:
a first roller and a second roller,
wherein the first roller and the second roller are configured to support a banner, the banner comprising a plurality of symbols arranged for display lengthways along the banner, and
wherein the first roller is configured to furl a first end of the banner and the second roller is configured to furl a second end of the banner such that a symbol in the plurality of symbols is positioned for display between the first roller and the second roller;
an actuator configured to rotate at least one of the first roller and the second roller to thereby adjust which symbol in the plurality of symbols is positioned for display between the first roller and the second roller; and
a first processor configured to control the actuator, wherein the first processor is configured to:
receive, from a second processor, a command comprising an indication to display a specific symbol of the plurality of symbols; and
output, to the actuator, instructions to display the specific symbol.

2. The device of claim 1, wherein the first processor is within a slave unit and the second processor is within a master unit.

3. The device of claim 1, wherein the command is received at the second processor from a remote controller.

4. The device of claim 1, wherein the device further comprises the banner.

5. The device of claim 4, wherein the banner comprises substantially opaque and substantially transparent parts, wherein the substantially opaque and substantially transparent parts of the banner define the symbols of the plurality of symbols.

6. The device of claim 4, wherein the banner is two-sided and wherein the symbol positioned for display between the first roller and the second roller is viewable from both sides of the banner.

7. The device e claim 1, wherein the plurality of symbols arranged for display lengthways along the banner comprises a transparent symbol.

8. The device claim 4, wherein the banner comprises a plurality of identifiers, each identifier being associated with a respective symbol in the plurality of symbols, and
wherein the device further comprises a reader communicatively coupled to the first processor, the reader configured to:
read an identifier associated with the symbol positioned for display between the first roller and the second roller; and
communicate the identity of the symbol positioned for display between the first roller and the second roller to the first processor.

9. The device of claim 8, wherein each identifier in the plurality of identifiers is positioned along the banner such that, when a specific identifier is positioned within a readable range of the reader, the symbol associated with the specific identifier is displayed between the first and second rollers.

10. The device of claim 8, wherein the plurality of identifiers comprise a plurality of RFID tags and the reader comprises an RFID reader.

11. The device of claim 1, wherein the banner comprises a plurality of position control elements, each position control element being associated with a respective symbol in the plurality of symbols, and
wherein the device further comprises a position sensing mechanism configured to:
identify when the symbol positioned for display between the first roller and the second roller is displayed correctly by sensing the position control element associated with the symbol; and
communicate that the symbol is displayed correctly between the first and second roller to the first processor.

12. The device of claim 11, wherein the position sensing mechanism comprises a through-beam sensing mechanism comprising a transmitter and a receiver positioned either side of the banner,
wherein the transmitter is configured to direct a beam toward the receiver,
wherein the receiver is communicatively coupled with the first processor and configured to receive the beam of radiation,
wherein each position control element in the plurality of position control elements are positioned along a length of the banner such that the position sensing mechanism is configured to sense the position control element associated with the symbol by identifying when the position control element intersects the beam.

13. The device of claim 1, further comprising at least one pole mount for mounting the device to the vessel.

14. The device of claim 13, wherein the at least one pole mount is configured to mount the device onto a flagpole.

15. An apparatus for displaying a plurality of nautical symbols on a vessel, the apparatus comprising:
a plurality of devices, each configured to display respective specific symbol,
wherein each device of the plurality of devices are positioned with respect to one another on a support structure such that the respective specific by at least a subset of the plurality of devices can be viewed together to form a message, and
wherein each of the plurality of devices comprises:
a first roller and a second roller, where the first roller a second roller are configured to support a banner, the banner comprising a plurality of symbols arranged for display lengthways along the banner, and wherein the first roller is configured to furl a first end of the banner and the second roller is configured to furl a second end of the banner such that a symbol in the plurality of symbols is positioned for display between the first roller and the second roller;
an actuator configured to rotate at least one of the first roller and the second roller to thereby adjust which symbol in the plurality of symbols is positioned for display between the first roller and the second roller; and
a first processor configured to control the actuator, wherein the first processor is configured to:
receive, from a second processor, a command comprising an indication for the device to display its respective specific symbol from amongst the plurality of symbols; and
output, to the actuator, instructions for the device to display its respective specific symbol.

16. The apparatus of claim 15, wherein the plurality of devices are positioned adjacent to one another on the support structure.

17. The apparatus of claim 15, wherein each device in the plurality of devices extends radially from a common central axis defined by the support structure.

18. The apparatus of claim 17, wherein each device in the plurality of devices extend radially from the common central axis with a uniform angular distribution.

19. (canceled)

20. (canceled)

21. (canceled)

22. (canceled)

23. A computer-implemented method of adjusting a displayed symbol on a device, wherein the device comprises
a first roller and a second roller, wherein the first roller and the second roller are configured to support a banner, the banner comprising a plurality of symbols arranged for display lengthways along the banner, and wherein the first roller is configured to furl a first end of the banner and the second roller is configured to furl a second end of the banner such that a symbol in the plurality of symbols is positioned for display between the first roller and the second roller;
an actuator configured to rotate at least one of the first roller and the second roller to thereby adjust which symbol in the plurality of symbols is positioned for display between the first roller and the second roller; and
a first processor configured to control the actuator,
the method comprising:
receiving, at the first processor, from a second processor, a command comprising an indication to display a specific symbol in the plurality of symbols; and
outputting, to the actuator, instructions to display the specific symbol.

24. The method of claim 23, further comprising, prior to receiving the command at the first processor, receiving at a remote controller, a user input indicating the specific symbol to display; and
sending, by the remote controller, to the second processor, the indication to display the specific symbol.

25. (canceled)

26. (canceled)

27. (canceled)
